(19) United States
(12) Patent Application Publication
(10) Pub. No.: US 2015/0277000 A1
(43) Pub. Date: Oct. 1, 2015

(54) DOMED SURVEILLANCE CAMERA INCLUDING MEANS FOR BLOCKING SCATTERED REFLECTION AND STRAY LIGHT

(71) Applicant: Powertech Electronics Co., Ltd., Incheon (KR)

(72) Inventor: Cheong Ho Lee, Incheon (KR)

(73) Assignee: Powertech Electronics Co., Ltd., Incheon (KR)

(21) Appl. No.: 14/616,348

(22) Filed: Feb. 6, 2015

(30) Foreign Application Priority Data
Mar. 28, 2014 (KR) 10-2014-0037127

(51) Int. Cl. G02B 5/20; G02B 13/14

(52) U.S. Cl. CPC G02B 5/208; G02B 13/14

(57) ABSTRACT

A domed surveillance camera capable of blocking scattered reflection and stray light. The domed surveillance camera may include an infrared camera module configured to include a lens, infrared lighting components disposed around the infrared camera module, and a domed cover configured to surround the infrared camera module and the infrared lighting components. Infrared shielding structure configured to block infrared rays from the infrared lighting components from being reflected by the domed cover and being incident on a lens is formed to cross the thickness of the domed cover within the domed cover. The surveillance camera can prevent the distortion of a captured image by blocking stray light incident on the lens due to scattered reflection.

This application is based on and claims priority from Korean Patent Application No. 10-2014-0037127, filed on Mar. 28, 2014, with the Korean Intellectual Property Office and issued as Korean Patent No. 10-1457138, the disclosure of which is incorporated herein in its entirety by reference.

### BACKGROUND OF THE INVENTION

1. Technical Field

The present disclosure relates to a domed surveillance camera, and, more particularly, to a domed surveillance camera capable of preventing the distortion of an image attributable to stray light that occurs due to, for example, scattered reflection.

2. Background

There is known a surveillance camera capable of capturing images not only in the daytime but also the nighttime. Such a surveillance camera is equipped with lighting means for imaging at night. In general, an infrared lighting means is usually used as the lighting means for a surveillance camera. In particular, an infrared light-emitting diode (IR LED) is widely adopted due to advantages, such as relatively low expense and long lifespan.

Korean Unexamined Utility Model Publication No. 20-2011-0007812 discloses a surveillance camera capable of day and night imaging by adopting IR LEDs as lighting means. The conventional camera is configured to dispose the plurality of IR LEDs around the lens unit of the camera and to capture an image by detecting infrared rays reflected by and returned from an external object by a photo sensor, such as a CMOS or CCD, via optical parts, such as a camera lens, after the illumination light of the IR LEDs passes through a domed cover at night.

Furthermore, the lens unit is configured to be closely attached to a surface of a domed cover in order to block some of the light emitted from the IR LEDs from being re-reflected by a surface of the domed cover and then being incident on the lens again.

### SUMMARY

The conventional surveillance camera is advantageous in that imaging is possible even at night because it is equipped with the IR LEDs, but is problematic in that a captured image is distorted because light output by the lighting means is re-reflected by the domed cover onto the camera and then incident on the lens.

In order to handle such a problem, it was suggested that the space on which stray light occurring due to scattered reflection in the domed cover may be incident should be reduced, i.e., designing the camera such that the lens is installed close to a surface of the domed cover to the maximum. However, another problem occurred in that it was difficult to increase adhesion between the domed cover and the lens to the extent that stray light is fully blocked due to the camera structure in which the lens is required to be rotated relative to the domed cover. Furthermore, if a separate device is installed at the entrance of the lens in order to improve such adhesion, many problems, such as an increase in the number of parts, increased complexity of the device, failures and malfunctions, are generated.

Accordingly, the present invention provides a surveillance camera capable of providing a high-quality surveillance image by blocking stray light attributable to scattered reflection.

Furthermore, the inventors of the present invention found that some of infrared rays output by infrared lighting means travel into the domed cover and are subject to scattered reflection at the outer surface of the domed cover and then become incident on the lens. Accordingly, the inventors have recognized that a new approach is required because such stray light problems may not be solved by increasing adhesion between the lens unit and the domed cover.

Accordingly, the present invention provides a surveillance camera capable of providing a high-quality captured image by blocking stray light that is reflected by the inner and outer surfaces of the domed cover and then incident on the lens.

The present invention provides a surveillance camera further including infrared shielding means. More specifically, the present invention solves an image distortion problem attributable to scattered reflection and stray light re-reflected by the domed cover by further including an infrared shielding means in the domed cover.

Accordingly, a domed surveillance camera in accordance with an embodiment comprises an infrared camera module including a lens, infrared lighting means disposed around the infrared camera module, and a domed cover surrounding the infrared camera module and the lighting means, wherein an infrared shielding means is formed within the domed cover to occupy the thickness of the domed cover, thereby preventing infrared rays emitted from the lighting means from being reflected by the domed cover and being incident on the lens.

Furthermore, in the domed surveillance camera in accordance with an embodiment, the infrared shielding means is integrated with the domed cover.

Furthermore, in the domed surveillance camera in accordance with an embodiment, the domed cover is made of transparent materials that transmit the infrared rays, and the infrared shielding means is made of opaque materials that do not transmit the infrared rays.

Furthermore, in the domed surveillance camera in accordance with an embodiment, the infrared shielding means is integrated with the domed cover through an injection process.

Furthermore, in the domed surveillance camera in accordance with an embodiment, the domed cover and the infrared shielding means are made of polycarbonate.

Furthermore, in the domed surveillance camera in accordance with an embodiment, the domed cover and the infrared shielding means are made of acryl.

Furthermore, in the domed surveillance camera in accordance with an embodiment, the domed cover is made of either polycarbonate or acryl, and the infrared shielding means is made of metal materials.

Furthermore, in the domed surveillance camera in accordance with an embodiment, the infrared shielding means is formed as a U-shaped frame in the domed cover along a path in which the camera module is configurable, whereby providing infrared shielding to a region in which the camera module is configured to rotate or tilt up and down.

Furthermore, in the domed surveillance camera in accordance with an embodiment, the infrared shielding means includes protrusions that protrude into an internal space surrounded by the domed cover.

Furthermore, the infrared shielding means further includes lateral protrusions so that part of the infrared shielding means is inserted into the domed cover and combined with the domed cover.

Furthermore, in the domed surveillance camera in accordance with an embodiment, the infrared shielding means is configured to block the infrared rays from the infrared lighting means from traveling along the domed cover and being incident on the lens.

Furthermore, in the domed surveillance camera in accordance with an embodiment, the infrared shielding means is configured to block the infrared rays from the infrared lighting means from being reflected by the inner and outer surfaces of the domed cover and being incident on the lens.

Furthermore, in the domed surveillance camera in accordance with an embodiment, the infrared shielding means is placed on the light path in which the infrared rays from the infrared lighting means is reflected by the domed cover and incident on the lens.

The surveillance camera in accordance with an embodiment is capable of photographing at night because it includes the infrared lighting means and is capable of capturing an image that has not been distorted by blocking scattered reflection and stray light occurring because infrared rays output by the infrared lighting means are reflected by the domed cover.

### BRIEF DESCRIPTION OF THE DRAWINGS

FIG. 1 is a diagram illustrating a conventional domed surveillance camera.

FIG. 2 is a diagram illustrating the travel path of some of illumination light in the conventional domed surveillance camera.

FIGS. 3a and 3b are diagrams illustrating a domed surveillance camera in accordance with an embodiment.

FIG. 4 is a diagram illustrating that scattered reflection and stray light are blocked in the domed surveillance camera in accordance with an embodiment.

FIGS. 5a and 5b are diagrams illustrating the domed cover of the domed surveillance camera in accordance with an embodiment.

FIG. 6 is a diagram illustrating the infrared shielding means of the domed surveillance camera in accordance with an embodiment.

FIG. 7 is a diagram illustrating a cross section of the domed cover of the domed surveillance camera in accordance with an embodiment.

FIG. 8 is a diagram illustrating an image captured by the conventional surveillance camera.

FIG. 9 is a diagram illustrating an image captured by the surveillance camera in accordance with an embodiment.

### DETAILED DESCRIPTION

Hereinafter, the present invention is described in detail with reference to the accompanying drawings.

A device described hereinafter in accordance with an embodiment is merely an example according to the present invention, and the scope of the present invention is not limited thereto. Those skilled in the art to which the present invention pertains may easily practice the present invention described in the claims with reference to the following description and may perform various changes and modifications within the technical spirit of the present invention.

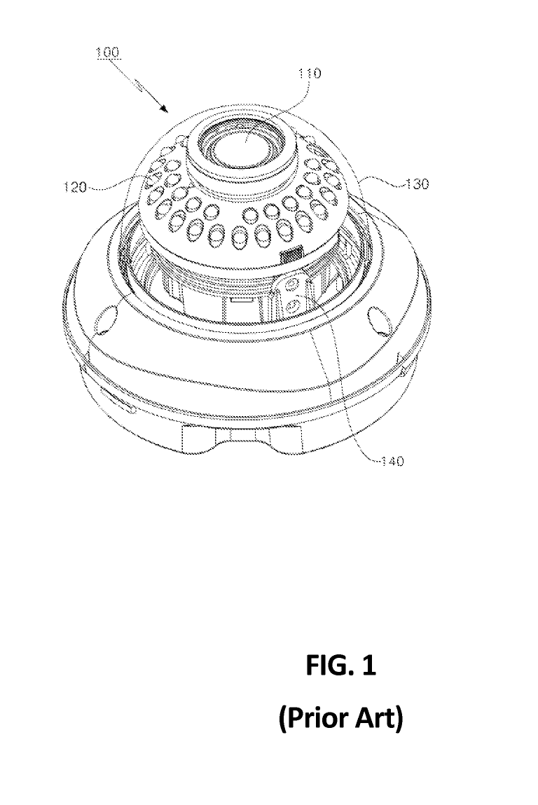

FIG. 1 is a diagram illustrating a conventional domed surveillance camera 100. A surveillance camera includes a camera module 110, a plurality of IR LEDs 120, a domed cover 130, and rotation supports 140. The domed surveillance camera captures an image using natural light in the daytime. The domed surveillance camera switches on the IR LEDs at night and captures an image using light that is reflected by an object after the light passes through the domed cover and is incident on the camera.

One or more IR LEDs 120 are installed, and the number of installed IR LEDs or the locations where the IR LEDs are installed may be determined according to the circumstances. For example, a small number of high-output LEDs may be installed instead of a plurality of low-output LEDs, a plurality of LEDs may be disposed in a circle in such a way as to surround the camera module where a lens is placed, or a plurality of LEDs may be disposed on both sides of the camera module in a bilateral symmetrical manner. Furthermore, a light detection sensor (not illustrated) may be disposed in a region where the IR LED is installed so that the IR LED is automatically turned on/off based on the result of the detection of surrounding light.

Rotation supports 140 function to rotate the camera module up and down. When the surveillance camera is installed, the orientation of the camera module may be set at a proper angle by taking the camera location and surveillance area into consideration. In general, the camera module is configured to rotate at least 180 degrees left and right. Thus, it may be sufficient for the range in which the camera module is rotated up and down by the rotation supports to be about 90 degrees. That is, if rotation within a range of 90 degrees up and down and rotation of 360 degrees left and right are used, all desired directions will likely be covered. The camera may be configured so that the orientation of the camera is changed by a manipulation at a remote place.

When such a conventional surveillance camera operates in lighting mode, infrared rays output by the IR LEDs are reflected by an object and are incident on the camera lens, thereby enabling the image capturing.

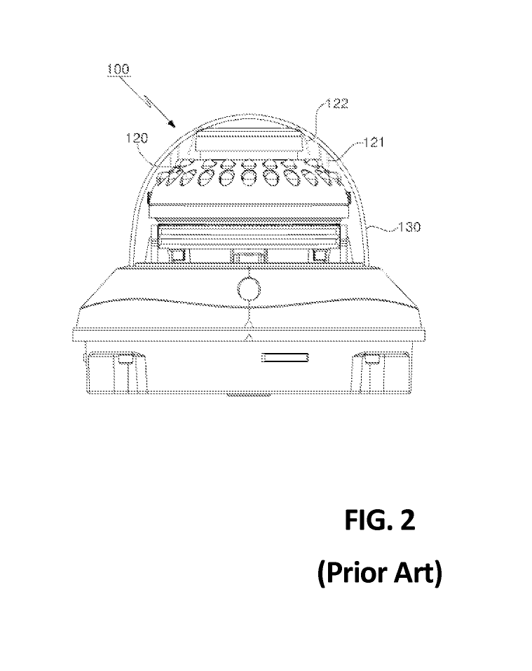

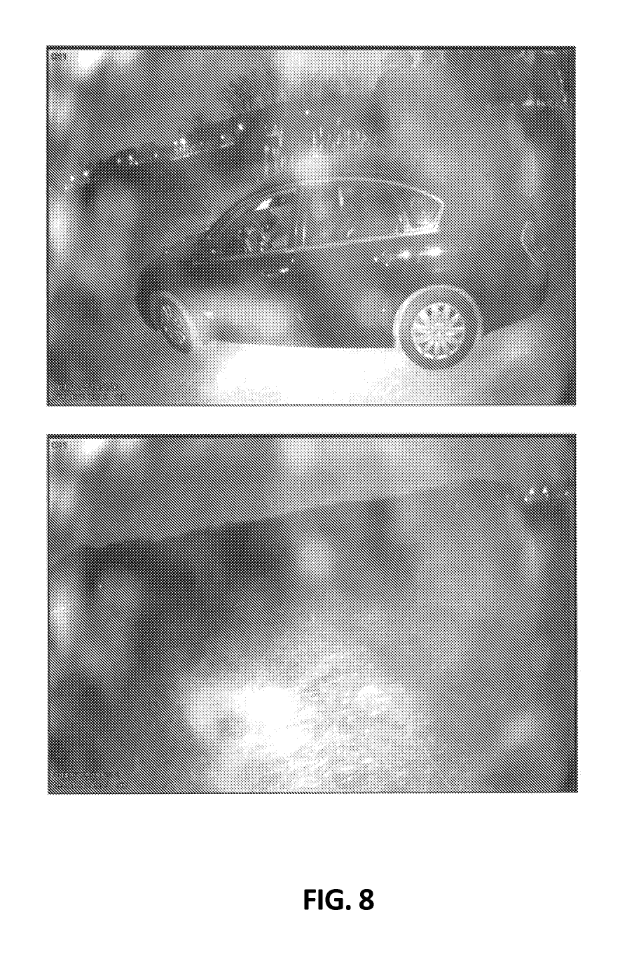

FIG. 2 is a diagram illustrating problems of the conventional domed camera. In the case of the conventional camera including the infrared lighting means, some of illumination light is reflected by the domed cover and incident on the camera lens, thereby generating an unwanted scattered reflection and stray light problem. Furthermore, in order to handle such stray light, attempts are made to block such stray light by closely attaching the camera lens to the domed cover to the maximum. However, as may be seen from FIG. 2 illustrating the path in which the infrared illumination light travels, some of illumination lights 121 and 122 travel into the domed cover thickness, and they are subject to scattered reflection by an outer surface of the domed cover and then incident on the lens. As a result, the stray light problem still remains unsolved. If such stray light is incident on the lens, unwanted distortion in which the screen becomes unclear, such as a moon halo shape (in general, it becomes apparent in the case of indoor image capturing), a stain shape, or a smoke and fog phenomenon (in general, it becomes apparent in the case of outdoor image capturing), is generated in a captured image. In particular, substances are likely to be attached to a surface of the domed cover because the domed cover is exposed to the outside. Furthermore, if the domed camera is installed outdoors, the distortion problem of a captured image due to stray light being subject to scattered reflection by an outer surface of the domed cover becomes more serious due to dust and raindrops when it rains. FIG. 8 illustrates an example of screen distortion that may occur when photographing is performed using the conventional camera.

Furthermore, the distortion problem of a captured image attributable to stray light due to such scattered reflection becomes more serious in a high-picture quality surveillance camera (e.g., an HDSDI dome camera or an IP dome camera) with a large number of pixels, which is now more widely used than the conventional domed analog surveillance camera.

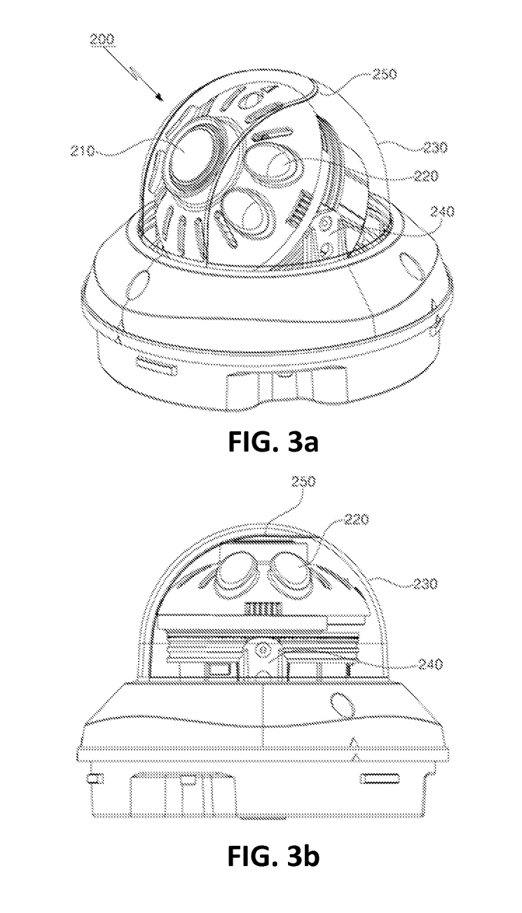

FIGS. 3a and 3b illustrate an embodiment of a domed camera 200 equipped with infrared shielding means. Such a domed camera includes a camera module 210, a domed cover 230, IR LEDs 220, and rotation supports 240. The infrared shielding means 250 is included in a domed cover 230. The camera module of the domed camera may be configured to be rotated about 90 degrees up and down by rotation supports 240. The IR LEDs are disposed on both sides of the camera module so that night image capturing is possible.

A domed cover 230 is provided to protect the camera module and is made of transparent materials. In general, a domed cover 230 is made of polycarbonate or acryl materials.

The infrared shielding means 250 is disposed along the boundary of a camera lens and the IR LEDs in a region of the domed cover 230 in which the camera module can be rotated or tilted up and down. The infrared shielding means is made of opaque materials, and it functions to prevent stray light, output by the IR LEDs and subject to scattered reflection by a surface of the domed cover, from being incident on the camera lens. In FIG. 3a and FIG. 3b, the infrared shielding means is configured in a U-shape along the domed cover, thus being capable of achieving an infrared shielding function irrespective of the location where the camera lens is installed.

The shape or installation location of such shielding means may be changed in various ways according to circumstances or requirements of the given camera systems. For example, if the camera module is a fixed type in which the camera module is not rotated or tilted up and down and the LEDs are circularly disposed around the camera lens, the infrared shielding means may be circularly formed in the domed cover along a boundary between the lens unit of the camera and the surrounding LEDs. That is, the infrared shielding means may be installed on the path in which scattered reflection and stray light travel, and the path is determined by the location of the camera module and the location where the infrared lighting means is installed in the camera.

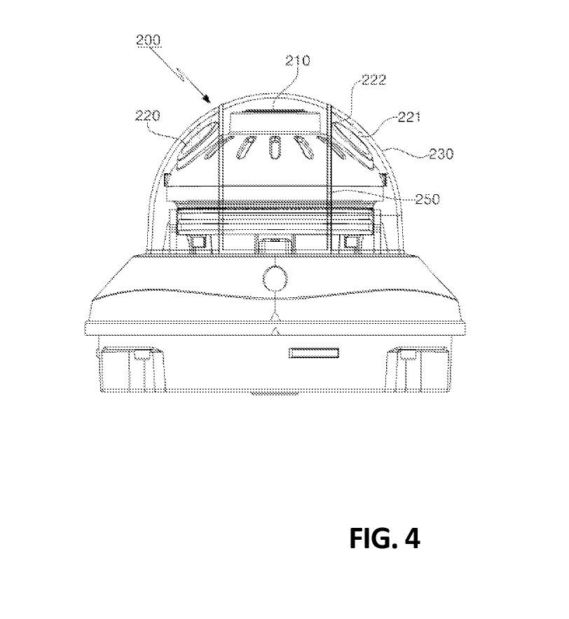

FIG. 4 is a diagram illustrating an example in which stray light traveling along the domed cover is blocked, in accordance with an embodiment. Stray light rays 221 and 222 from the illumination light travel along the domed cover and are subject to scattered reflection toward the lens are blocked by infrared shielding means 250 installed on the path in which the stray light rays travel, thereby preventing the distortion of an image. As described above, the shape of the infrared shielding means and the location where the infrared shielding means is installed may be changed by the location of the camera module in the domed camera and arrangement of the infrared lighting means. Most importantly, the infrared shielding means may be installed on the path in which stray light attributable to scattered reflection occurring in a specific surveillance camera structure travels towards the lens.

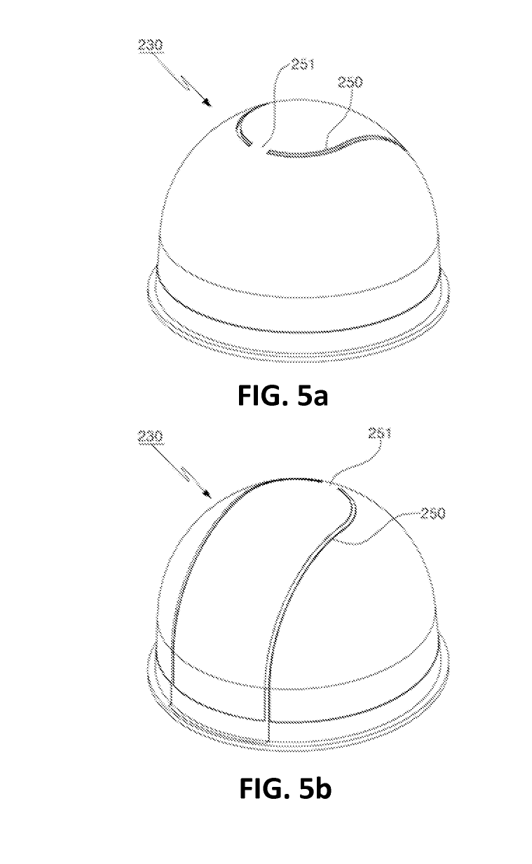

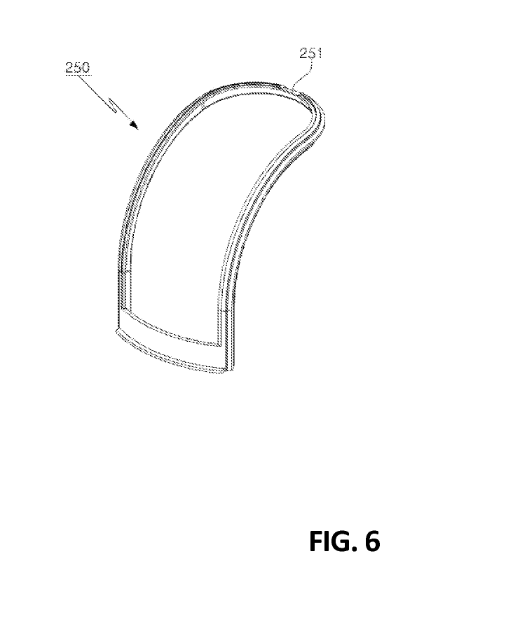

FIGS. 5a and 5b illustrate a domed cover 230 included in the domed surveillance camera in accordance with an embodiment. Infrared shielding means 250 is formed in a domed cover 230. A more detailed embodiment of infrared shielding means 250 is illustrated in FIG. 6.

The domed cover and the infrared shielding means may be integrated and formed through an injection process or a dual injection process. This is merely illustrative, and is not meant to limit the process of forming the domed cover and the infrared shielding means.

The infrared shielding means may be made of known materials capable of blocking infrared rays and is not limited to specific materials. The infrared shielding means may be made of opaque materials capable of blocking light including infrared rays. The infrared shielding means may be made of the same material as the domed cover. In this case, dyes capable of shielding infrared rays, that is, opaque materials, may be added to the materials so that the infrared shielding means has an infrared shielding property. For example, the infrared shielding means may be made of synthetic resin, such as opaque polycarbonate or acryl, or metals.

In FIG. 6, the part indicated by reference numeral 251 is a groove for injection formed in the infrared shielding means. First, a domed cover part other than a region in which the infrared shielding means is formed is formed by an injection process. After the infrared shielding means formed by a separate injection process is assembled with the domed cover part and mounted on a mold, a second injection process is performed. In this case, there is a need for a passage through which injection materials may travel into the U-shaped area. To this end, the groove for injection is formed. There is no special limit on the location where the groove for injection is formed. For example, the groove for injection may be formed in the base part of the U-shaped frame, as illustrated in FIG. 6. If dual injection is adopted, the process of fabricating the domed cover becomes simpler. The injection process or dual injection process is widely known to those skilled in the art, and a detailed description thereof has been omitted.

The thickness of infrared shielding means 250 may be the same as that of the domed cover. The thickness of part of or the entire infrared shielding means 250 may be greater than that of the domed cover so that the infrared shielding means is protruded into the internal space surrounded by the domed cover. In such a case, there is an advantage in that the range in which scattered reflection and stray light can be blocked is further increased.

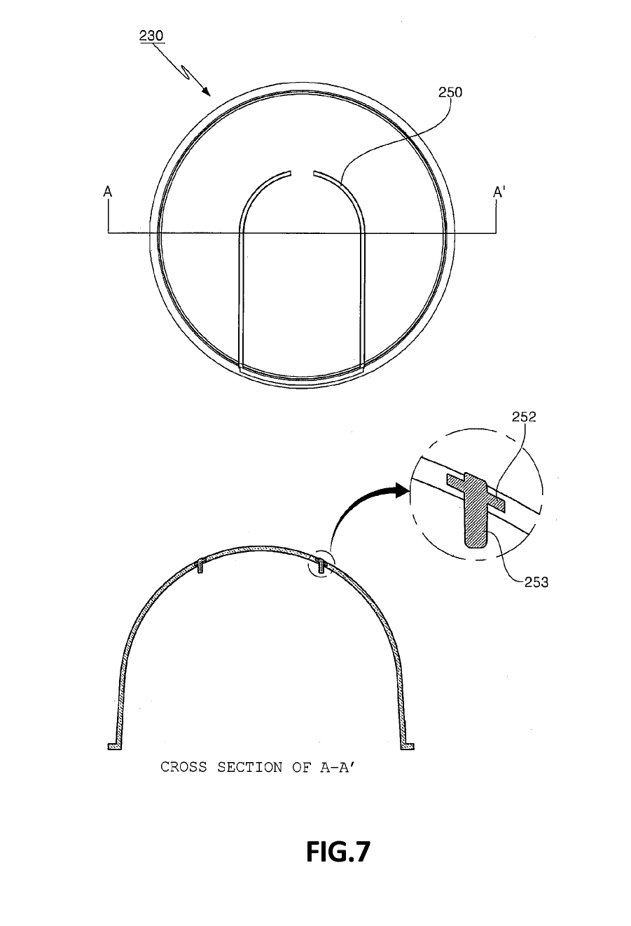

FIG. 7 illustrates a cross section of the domed cover on which the infrared shielding means in accordance with an embodiment is mounted. Referring to the cross section along line A-A′ of the domed cover, the infrared shielding means in accordance with an embodiment is configured to include first protrusions 253 protruded toward the internal space covered by domed cover and second protrusions 252 protruded in the direction in which the second protrusions 252 are combined with the domed cover. First protrusions 253 may function to block stray light that may be subject to scattered reflection by an inner surface of the domed cover and then incident on the lens. First protrusions 253 extend the range of blocking scattered reflection and stray light. The protruded length of the first protrusion may be about 3.5 mm to 4 mm, for example. The width of the first protrusion is not specially limited and may be about 1.5 mm, for example. The illustrated length and width are only illustrative, and the length, width, and shape of the first protrusion may be adapted to the structure of the surveillance camera. Furthermore, the infrared shielding means in accordance with an embodiment includes second protrusions 252 protruded along the domed cover so that the infrared shielding means is firmly combined with the domed cover. Due to the second protrusions 252, the domed cover part outside the infrared shielding means, the infrared shielding means, and the domed cover part inside the U-shape of the infrared shielding means can be firmly coupled. If the domed cover and the infrared shielding means are coupled through surface attachment without the second protrusions, cohesiveness between the domed cover and the infrared shielding means would be weak. In this case, if a specific impact is applied, part of the infrared shielding means or the domed cover may be separated and chipped off during an injection process or while using the surveillance camera. Furthermore, as illustrated in the enlarged view of the cross section of FIG. 7, the second protrusion may be protruded in both directions in which the infrared shielding means is combined with the domed cover. The shape, size, or structure of the second protrusion may be properly selected and designed according to a specific surveillance camera structure within the technical spirit of the present invention.

FIG. 8 illustrates images captured at night using a surveillance camera on which a conventional domed cover was mounted when the infrared lighting means of the surveillance camera was on. The upper image is an image of a vehicle, that is, an object of imaging, and the lower image is an image of an open space. As described above in relation to the prior art, if image capturing is performed at night using the surveillance camera on which the conventional domed cover is mounted, it may be seen that a moon halo phenomenon in which a moon halo pattern is generated and a smoke and fog phenomenon in which an image becomes generally stained and clouded are generated because part of illumination light is subject to scattered reflection by the domed cover and is incident on the lens, as illustrated in FIG. 8.

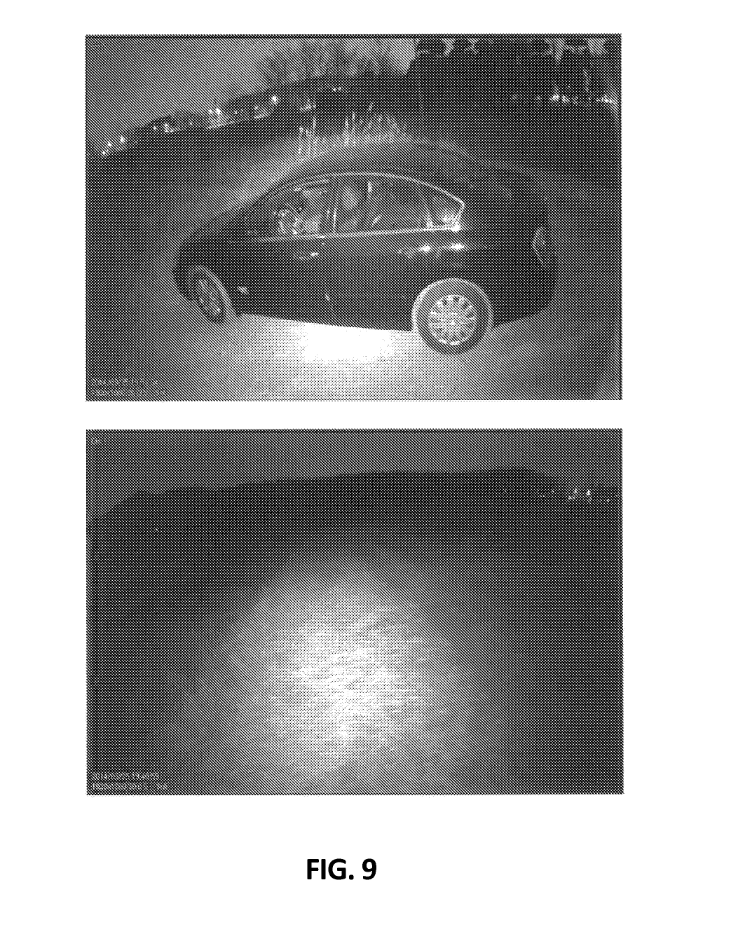

FIG. 9 illustrates images captured using the surveillance camera on which the domed cover including the infrared shielding means in accordance with an embodiment was mounted. The images were captured using the same camera under the same conditions as those of FIG. 8 except that the domed cover in accordance with an embodiment was installed. From FIG. 9, it can be seen that high quality images not including an image distortion phenomenon attributable to the scattered reflection of illumination light in the domed cover were captured, compared to the images of FIG. 8.

The embodiments in which the infrared shielding means is installed in the domed cover have been described in detail. In order to handle a variety of types of scattered reflection and stray light, blocking scattered reflection and stray light can be maximized by installing the infrared shielding means in the domed cover and coupling conventional light blocking structures (e.g., a structure in which the entrance of a lens is closely attached to the domed cover, such as light blocking bushing proposed in Korean Unexamined Utility Model Publication No. 20-2011-0007812) with the domed cover.

The present invention can provide the domed surveillance camera capable of day and night image capturing and of preventing the distortion of a captured image attributable to the scattered reflection and stray light of illumination light from the infrared lighting means.

From the foregoing, it can be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A domed surveillance camera comprising:
an infrared camera module including a lens;
infrared lighting means disposed around the infrared camera module; and
a domed cover surrounding the infrared camera module and the infrared lighting means;
wherein infrared shielding means is formed within the domed cover to occupy the thickness of the domed cover, thereby preventing infrared rays from the infrared lighting means and reflected by the domed cover from being incident on the lens.

2. The domed surveillance camera of claim 1, wherein the infrared shielding means is integrated with the domed cover.

3. The domed surveillance camera of claim 1 or 2, wherein:
the domed cover is made of transparent materials that transmit the infrared rays, and
the infrared shielding means is made of opaque materials that do not transmit the infrared rays.

4. The domed surveillance camera of claim 2, wherein the infrared shielding means is integrated with the domed cover through an injection process.

5. The domed surveillance camera of claim 3, wherein the domed cover and the infrared shielding means are made of polycarbonate.

6. The domed surveillance camera of claim 3, wherein the domed cover and the infrared shielding means are made of acryl.

7. The domed surveillance camera of claim 3, wherein the domed cover is made of either polycarbonate or acryl, and the infrared shielding means is made of metal materials.

8. The domed surveillance camera of claim 1, wherein the infrared shielding means is formed as a U-shaped frame in the domed cover along a path defining a U-shaped region in which the camera module is configurable, whereby providing infrared shielding to the region in which the camera module is configured to rotate or tilt up and down.

9. The domed surveillance camera of claim 1, wherein the infrared shielding means further comprises protrusions that protrude into an internal space surrounded by the domed cover.

10. The domed surveillance camera of claim 9, wherein the infrared shielding means further comprises lateral protrusions so that part of the infrared shielding means is inserted into the domed cover and combined with the domed cover.

11. The domed surveillance camera of claim 1, wherein the infrared shielding means is configured to block the infrared rays from the infrared lighting means from traveling along the domed cover and being incident on the lens.

12. The domed surveillance camera of claim 1, wherein the infrared shielding means is configured to block the infrared rays from the infrared lighting means from being reflected by inner and outer surfaces of the domed cover and being incident on the lens.

13. The domed surveillance camera of claim 1, wherein the infrared shielding means is placed on a light path in which the infrared rays from the infrared lighting means is reflected by the domed cover and incident on the lens.
